(19) United States
(12) Patent Application Publication
(10) Pub. No.: US 2026/0368038 A1
(43) Pub. Date: Nov. 19, 2026

(54) SELF-RESETTING HARDWARE ENFORCEMENT CIRCUIT WITH AUTONOMOUS MULTI-PHASE RECOVERY AND ADAPTIVE BACK-OFF

(71) Applicant: Jonathan Washburn, Austin, TX (US)

(72) Inventor: Jonathan Washburn, Austin, TX (US)

(21) Appl. No.: 19/676,361

(22) Filed: May 13, 2026

Related U.S. Application Data
(60) Provisional application No. 63/805,949, filed on May 14, 2025.

(51) Int. Cl. G06F 11/14

(52) U.S. Cl. CPC G06F 11/1441; G06F 11/142

(57) ABSTRACT

A self-resetting hardware enforcement circuit includes a violation monitor, a persistence circuit, a reset sequencer, a back-off circuit, and a self-clear circuit. The persistence circuit asserts a trigger signal when a programmable enforcement condition associated with a violation signal is satisfied. In response, the reset sequencer performs an ordered recovery operation for a target logic domain, including isolate, purge, and resume phases, without requiring firmware or software intervention. The back-off circuit inhibits retriggering during an increased back-off interval after an enforcement event. The self-clear circuit releases a retrigger mask and returns the circuit to a retriggerable standby condition after the back-off interval expires when no unmasked violation condition remains.

### CROSS-REFERENCE TO RELATED APPLICATIONS

This application claims the benefit of priority to U.S. Provisional Patent Application No. 63/805,949, filed May 14, 2025, the entirety of which is hereby incorporated by reference herein.

### BACKGROUND

The present disclosure relates generally to digital logic safety mechanisms, fault-tolerant computer architectures, autonomous reset circuits, hardware enforcement mechanisms, and integrated circuits configured to recover a target logic domain from a detected violation condition without firmware or software intervention. More particularly, the disclosure relates to a self-resetting hardware enforcement circuit configured to receive one or more violation signals from a target logic domain, determine whether a programmable enforcement condition has been satisfied, perform a sequenced recovery operation, apply back-off, and self-clear to a retriggerable standby condition.

Digital systems commonly include watchdog timers, reset supervisors, error detectors, interrupt handlers, exception mechanisms, firmware recovery routines, or safety monitors. These mechanisms can detect at least some forms of malfunction and can initiate recovery action. However, conventional mechanisms generally suffer from one or more limitations that are addressed by the present disclosure.

Conventional watchdog timers typically generate a reset when a monitored condition is not satisfied within a fixed timeout interval. In many systems, the reset is global or coarse-grained. Such a reset can clear both valid and corrupted state, interrupt unrelated logic, destroy useful in-progress computation, and require substantial restart time. A conventional watchdog may not distinguish between transient local corruption and a system-wide failure, and may not provide a targeted reset of only an affected logic domain.

Firmware-controlled recovery mechanisms introduce additional limitations. Firmware may be delayed, unavailable, or executing incorrectly at the time a violation occurs. Firmware can be compromised by the same fault, attack, or imbalance that requires recovery. Firmware recovery can also add latency and design complexity, particularly where deterministic hardware response is desired.

Some hardware safety circuits detect parity errors, error-correction-code errors, timing violations, voltage excursions, thermal excursions, missed heartbeat events, or physical attack conditions. However, such circuits often merely report an error, generate an interrupt, or invoke a conventional reset path. They generally do not provide a compact autonomous enforcement circuit that detects a programmable violation condition, performs a structured isolate, purge, and resume recovery sequence, applies increasing back-off to prevent repeated reset storms, maintains a retrigger mask, and then self-clears to a retriggerable standby condition.

Existing reset systems may produce oscillatory reset storms when an underlying violation persists or recurs quickly. A reset storm may prevent useful diagnosis, increase power consumption, and prevent controlled recovery. Existing approaches may require firmware policy decisions, external supervisors, or manual intervention to suppress repeated resets.

Existing systems also often lack a unified circuit architecture capable of interpreting multiple types of violation semantics. A violation may be a persistent asserted level, an absent heartbeat, a rate or burst of events, a ledger imbalance, a protocol violation, a physical attack indication, or another detectable condition. Treating all such signals as identical watchdog events can reduce precision and flexibility.

There remains a need for a self-resetting hardware enforcement circuit that autonomously monitors one or more violation conditions, determines when a programmable enforcement criterion is satisfied, inhibits operation of a target logic domain, applies reset state or clearing state to selected volatile or sequential logic, permits the target logic domain to resume operation, applies increasing back-off, and self-clears to a retriggerable standby condition without requiring firmware or software intervention.

Even staged reset controllers that perform ordered reset assertion and release generally do not combine programmable persistence-based violation detection, sequenced isolate/purge/resume recovery, increasing post-enforcement back-off, retrigger masking during recovery and back-off, and autonomous self-clear to a retriggerable standby condition when no unmasked violation condition remains.

### SUMMARY

The disclosure provides a self-resetting hardware enforcement circuit. In a broad embodiment, the circuit autonomously monitors at least one violation signal associated with a target logic domain, determines whether a programmable enforcement condition has been satisfied, performs a sequenced recovery operation for the target logic domain, applies a back-off interval after enforcement, maintains a retrigger mask, and self-clears to a retriggerable standby condition after expiration of the back-off interval when no unmasked violation condition remains.

In one embodiment, the enforcement circuit includes a violation monitor, a persistence circuit, a reset sequencer, a back-off circuit, and a self-clear circuit. The persistence circuit asserts a trigger signal when the programmable enforcement condition associated with the violation signal has been satisfied. The reset sequencer responds to the trigger signal by performing a sequenced recovery operation including an isolate phase, a purge phase, and a resume phase.

During the isolate phase, operation of at least a portion of the target logic domain is inhibited. During the purge phase, reset state or clearing state is applied to selected volatile or sequential logic of the target logic domain. During the resume phase, the reset state or clearing state is released and operation of the target logic domain is permitted to resume.

The back-off circuit inhibits re-triggering of the reset sequencer during a back-off interval following the sequenced recovery operation. In preferred embodiments, the back-off interval is increased after an enforcement event. In a binary-exponential embodiment, the back-off interval doubles after repeated enforcement events until a maximum back-off value is reached. In one preferred embodiment, the maximum back-off value is 2°enforcement clock cycles.

The self-clear circuit maintains a retrigger mask during at least a portion of the sequenced recovery operation or the back-off interval. The self-clear circuit returns the enforcement circuit to a retriggerable standby condition after expiration of the back-off interval when no unmasked violation condition remains.

In certain embodiments, the violation monitor includes a plurality of independently enabled violation channels. Each violation channel may be coupled to a corresponding persistence counter. In a preferred embodiment, the plurality of independently enabled violation channels includes eight violation channels corresponding to eight stages, ticks, phases, or positions of an execution frame.

In certain embodiments, the violation monitor includes a multi-stage synchronizer configured to synchronize an asynchronous violation input into an enforcement clock domain and to generate at least one of a synchronized level signal or a one-cycle event pulse from the asynchronous violation input.

In certain embodiments, the programmable enforcement condition includes a persistent-level condition, a missing-heartbeat condition, a rate-monitoring condition, or a combination thereof. In persistent-level mode, a fault indication remains asserted for a threshold number of enforcement clock cycles. In missing-heartbeat mode, a required activity signal is absent for a threshold number of enforcement clock cycles. In rate-monitoring mode, event activity exceeds a programmable threshold.

In a preferred Recognition Science or ledger-enforcement embodiment, the isolate phase has a duration of two enforcement clock cycles, the purge phase has a duration of four enforcement clock cycles, and the resume phase has a duration of two enforcement clock cycles. The sequenced recovery operation therefore has a total duration of eight enforcement clock cycles corresponding to an eight-tick cadence of an execution frame or enforcement octave.

In certain embodiments, at least one property of the reset sequencer, back-off circuit, or self-clear circuit is machine-verified using a formal proof system. In one embodiment, the formal proof system includes Lean 4, and the verified property includes return to standby after the sequenced recovery operation, an eight-cycle default enforcement duration, monotonicity of back-off, maximum back-off value, self-clear semantics, or eight-channel correspondence.

The enforcement circuit may be embodied in an integrated circuit, processor, safety processor, secure enclave, accelerator, memory controller, quantum-control processor, photonic processor controller, clock-domain-crossing interface, ledger-enforced processing core, system-on-chip, chiplet, semiconductor die, or other hardware product. The enforcement circuit may also be embodied as hardware-description information, including RTL, a gate-level netlist, configuration data, synthesis scripts, place-and-route collateral, formal specification files, formal proof artifacts, or a non-transitory computer-readable medium storing such materials.

### BRIEF DESCRIPTION OF THE DRAWINGS

FIG. 1 illustrates a top-level block diagram of a self-resetting hardware enforcement circuit coupled to a target logic domain.

FIG. 2 illustrates a violation monitor and synchronization architecture for one or more violation channels.

FIG. 3 illustrates persistence counter and programmable trigger logic supporting multiple violation-detection modes.

FIG. 4 illustrates a reset sequencer state diagram including standby, isolate, purge, resume, and back-off states.

FIG. 5 illustrates timing waveforms for violation assertion, trigger generation, target-domain inhibition, target-domain reset or clearing, back-off masking, and self-clear operation.

FIG. 6 illustrates a back-off circuit and self-clear circuit architecture.

FIG. 7 illustrates hardware interface, configuration register, status register, and target-domain control circuitry.

FIG. 8 illustrates a ledger-enforced processor or Recognition Science instruction-set architecture embodiment in which a balance register or per-tick ledger signal drives the enforcement circuit.

FIG. 9 illustrates a multi-core or multi-domain system having a plurality of enforcement circuit instances.

FIG. 10 illustrates a formal verification, RTL, synthesis, and fabrication flow for producing or validating an enforcement circuit.

### DETAILED DESCRIPTION

The following description provides examples and implementation details for a self-resetting hardware enforcement circuit. The examples are provided to enable a person of ordinary skill in the art to make and use the disclosed invention and to describe preferred, optional, alternative, demonstrated, and prophetic embodiments. Unless expressly required by the claims, individual features described in connection with particular embodiments should not be understood as limiting all embodiments.

The core invention is an autonomous hardware enforcement circuit that monitors at least one violation signal associated with a target logic domain, determines whether a programmable enforcement condition has occurred, performs a sequenced recovery operation including isolate, purge, and resume phases, applies increasing back-off after an enforcement event, maintains a retrigger mask, and returns to a retriggerable standby condition after expiration of the back-off interval when no unmasked violation condition remains.

Unlike a watchdog timer that merely detects a timeout and asserts reset, the disclosed enforcement circuit performs a coordinated hardware enforcement loop: programmable persistence detection, sequenced isolation, purge, controlled resume, increasing back-off, retrigger masking, and conditional self-clear to retriggerable standby. The core circuit does not require eight channels, a particular semiconductor node, a ledger-enforced processor, Lean verification, or an eight-cycle timing sequence unless expressly recited.

When the disclosure states that the sequenced recovery operation is performed without firmware or software intervention, this means that firmware or software executing on the target logic domain is not required to perform the isolate phase, purge phase, resume phase, back-off operation, retrigger masking, or self-clear operation. Firmware or software may, in some embodiments, configure one or more registers before an enforcement event, load thresholds, enable or disable channels, select modes, read status information, receive diagnostic information, or perform post-recovery logging. Such configuration or diagnostic activity does not mean that firmware or software is required to complete the sequenced recovery operation.

The disclosed enforcement circuit is not limited to the particular labels used for individual circuit blocks. Terms such as self-resetting hardware enforcement circuit, self-resetting circuit, and enforcement circuit may refer to the same circuit or to cooperating portions of hardware logic configured to perform the disclosed monitoring, sequenced recovery, back-off, and self-clear operations. Similarly, terms such as reset sequencer, recovery sequencer, sequenced recovery controller, and state machine may refer to hardware control logic configured to perform the disclosed recovery sequence. The use of different labels for corresponding structures is not intended to require physically separate components unless separation is expressly stated. A single circuit block may perform multiple disclosed functions, and a disclosed function may be distributed across multiple hardware blocks.

As used in this disclosure, an enforcement circuit refers to hardware logic configured to detect or receive violation information, evaluate whether enforcement should occur, control one or more recovery signals of a target logic domain, and return to a standby or monitoring condition. An enforcement circuit may be implemented as standard-cell digital logic, custom logic, programmable logic, gate-array logic, RTL-defined logic, hard macro logic, soft macro logic, or a combination thereof.

As used in this disclosure, a target logic domain refers to a portion of digital or mixed-signal control logic whose state advancement, reset state, clearing state, or execution behavior can be controlled by the enforcement circuit. A target logic domain may include a processor core, pipeline, microcontroller, accelerator, cryptographic block, secure enclave, safety controller, photonic controller, quantum classical-control block, finite-state machine, subsystem, clock domain, power domain, reset domain, or other controllable logic region.

As used in this disclosure, a violation signal refers to a signal, flag, level, pulse, event, status bit, comparator output, monitor output, sensor output, balance indication, heartbeat indication, or other information indicating or relating to a condition for which enforcement may be appropriate. A violation signal need not itself be an error signal in every embodiment; for example, a heartbeat signal may be interpreted so that absence of an expected pulse constitutes a violation. Example violation signals include, without limitation, ledger imbalance signals, balance-register non-zero indications, protocol-violation flags, parity errors, ECC errors, uncorrectable memory-error flags, timing violations, voltage excursions, thermal excursions, clock-domain-crossing violations, missing-heartbeat conditions, excessive event-rate indications, physical attack sensor outputs, voltage-glitch detector outputs, laser-fault detector outputs, clock-frequency monitor outputs, photonic imbalance outputs, and syndrome-decoder inconsistency outputs.

A violation signal may be received from any suitable source associated with the target logic domain or its operating environment. Example violation sources include protocol monitors, illegal-operation detectors, privilege-violation detectors, parity checkers, error-correction-code checkers, memory-error detectors, timing monitors, slack monitors, voltage monitors, thermal monitors, power-droop detectors, clock-domain-crossing monitors, stuck-at or liveness detectors, missing-heartbeat sources, event-burst detectors, physical attack detectors, laser-fault detectors, optical sensors, clock-frequency monitors, calibration-failure detectors, balance registers, execution-frame monitors, photonic imbalance detectors, syndrome decoders, or external safety monitors.

As used in this disclosure, a programmable enforcement condition refers to any condition that can be selected, configured, loaded, set, trimmed, fused, masked, enabled, disabled, or otherwise defined to determine when an enforcement event is initiated. A programmable enforcement condition may be based on level persistence, timeout, threshold, absence of activity, heartbeat window, event count, rate, overflow, counter value, comparator output, polarity, channel enable, channel mode, back-off state, or a combination of such conditions.

As used in this disclosure, an enforcement event occurs when a trigger signal is accepted by the reset sequencer and causes the reset sequencer to begin the sequenced recovery operation. In other embodiments, an enforcement event may be measured from assertion of the trigger signal, entry into the isolate phase, entry into the purge phase, entry into the resume phase, completion of the sequenced recovery operation, update of the back-off circuit, or entry into a post-enforcement state. Unless otherwise stated, reference to increasing a back-off interval after an enforcement event includes increasing, loading, updating, or selecting the back-off interval in response to acceptance of a trigger signal that initiates the sequenced recovery operation.

In the disclosed embodiments, a retrigger mask may be implemented by any hardware logic, state bit, latch, gate, inhibit signal, busy indication, lockout state, arbitration state, trigger-suppression circuit, or equivalent structure that prevents, suppresses, gates, blocks, delays, ignores, or inhibits assertion or acceptance of a subsequent trigger while a sequenced recovery operation or back-off interval is active. The retrigger mask need not be located at a single point in the circuit. In different embodiments, retrigger masking may occur at one or more channel outputs, at a trigger-combination circuit, at an input of the reset sequencer, in a counter-update path, in a back-off circuit, or in a state-machine transition path.

A retriggerable standby condition is a non-enforcing monitoring condition in which the sequenced recovery operation is not active, the back-off interval is not active or no longer prevents trigger acceptance, the retrigger mask has been released, and the enforcement circuit is capable of responding to a future unmasked violation condition. In the retriggerable standby condition, target-domain halt, inhibit, reset, or clearing controls are preferably de-asserted or inactive, while monitoring logic, persistence logic, and configuration logic may remain powered and active. Thus, the enforcement circuit may be non-interfering with respect to normal operation of the target logic domain while remaining available to initiate a future enforcement event.

An unmasked violation condition is a violation condition that is enabled and not suppressed by a retrigger mask, not disabled by channel configuration, not ignored by mode logic, and not blocked by back-off logic. A masked, disabled, ignored, or suppressed condition may still be physically present as a signal, level, pulse, counter value, sensor output, or status indication, but is not treated as an accepted trigger for purposes of re-entering the sequenced recovery operation or preventing self-clear unless the configuration of the enforcement circuit so provides.

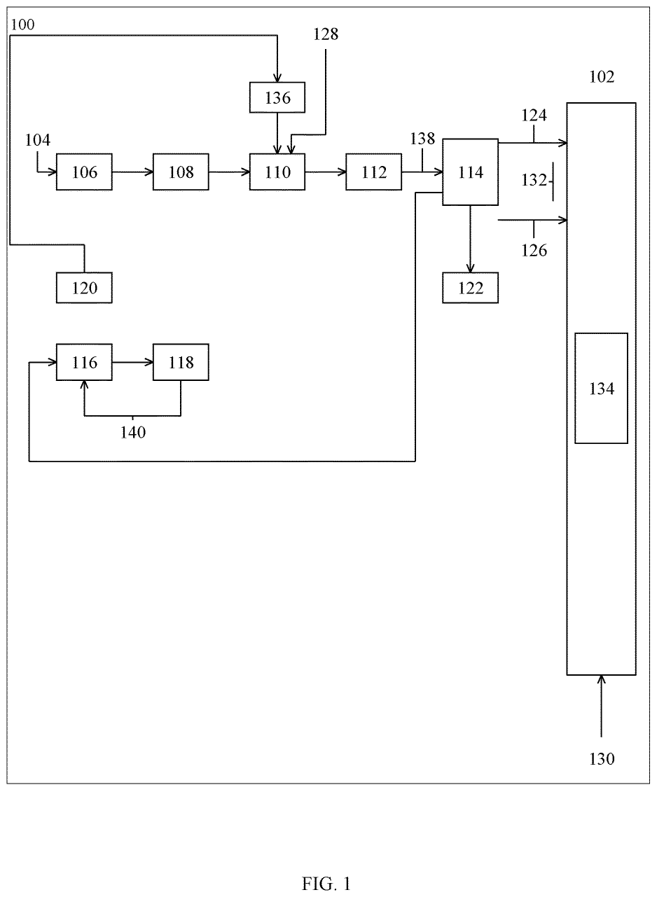

FIG. 1 depicts a top-level self-resetting enforcement circuit 100 coupled to a target logic domain 102. The target logic domain 102 may include, for example, a processor core, microcontroller, accelerator, controller, secure enclave, pipeline, state machine, classical controller for a quantum processor, photonic control circuit, or other digital logic block. The enforcement circuit 100 receives a violation input bus 104, which may include one or more violation signals. In a preferred embodiment, the violation input bus 104 includes up to eight violation signals. In other embodiments, the bus may include a single violation input, fewer than eight inputs, or more than eight inputs.

A violation monitor 106 receives the violation input bus 104 and provides channel-specific signal conditioning, enable control, polarity interpretation, and optional event-pulse generation. A synchronizer bank 108 synchronizes asynchronous violation signals into an enforcement clock domain. In a preferred implementation, each channel includes a two-flip-flop synchronizer, although other multi-stage synchronizers may be used. A persistence circuit or persistence counter block 110 evaluates whether one or more synchronized violation signals satisfy a programmable enforcement condition. A trigger combiner 112 receives one or more channel trigger outputs and causes a reset sequencer 114 to perform a sequenced recovery operation.

The reset sequencer 114 controls the target logic domain 102 by applying one or more target-domain control signals. Such controls may include a clock-halt output 124, a target reset output 126, an inhibit signal, a clearing signal, a clock-enable control, a write-inhibit signal, a commit-inhibit signal, a bus-isolation signal, or another signal that inhibits operation or applies reset state or clearing state to selected logic. A back-off circuit 116 imposes a retrigger-inhibition interval after an enforcement event. A self-clear circuit 118 returns the enforcement circuit 100 to a retriggerable standby condition after the back-off interval expires when no unmasked violation condition remains.

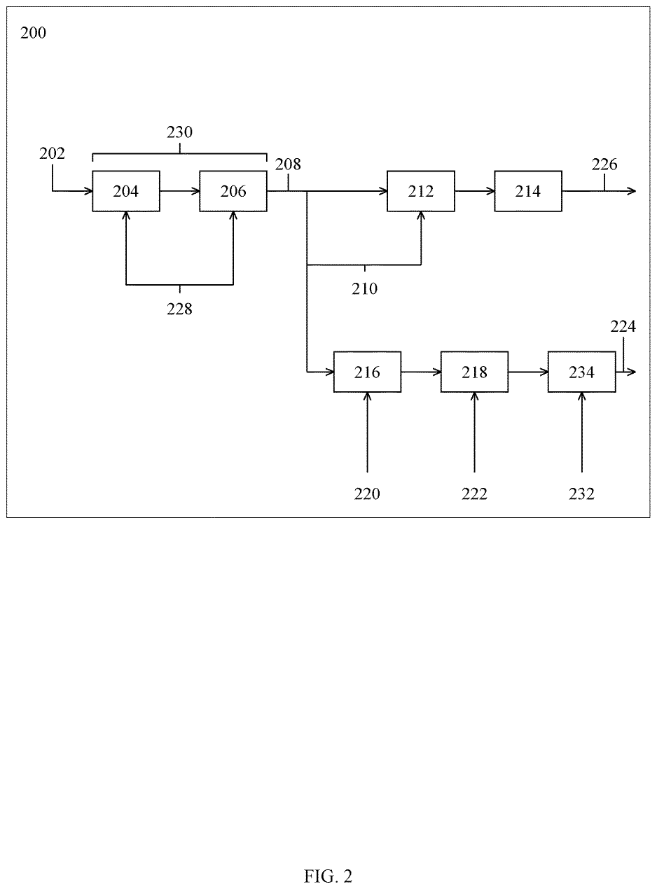

FIG. 2 depicts a violation monitor channel 200 suitable for use in the violation monitor 106 and synchronizer bank 108 of FIG. 1. The channel 200 receives an asynchronous violation input 202, which may be identified as VIOL[k]. The asynchronous violation input 202 may be applied to a first synchronizer flip-flop 204 and then to a second synchronizer flip-flop 206. Together, the first synchronizer flip-flop 204 and second synchronizer flip-flop 206 form a metastability barrier 230. The second synchronizer flip-flop 206 produces a synchronized violation level 208 in the enforcement clock domain.

In optional event-detection embodiments, the synchronized violation level 208 is compared by an edge detector 212 with a delayed synchronized level signal path 210. The delayed synchronized level signal path 210 may represent a one-cycle or otherwise delayed version of the synchronized violation level 208 and need not be shown as a separate hardware block. A one-cycle pulse normalizer 214 may generate a channel output pulse 226 having a duration of one enforcement clock cycle. The pulse output may be useful for rate, overflow, burst, or event-counting modes. A polarity selector 216 interprets the channel according to configuration information, and a channel enable gate 218 enables or disables the channel according to configuration.

The violation monitor channel 200 may generate a synchronized level signal, a one-cycle event pulse, or both. Persistent-level logic evaluates whether the synchronized level signal remains active for a configured interval. Missing-heartbeat logic evaluates whether expected activity is absent for a configured interval. Rate-monitoring logic evaluates whether event activity exceeds a configured threshold. The resulting channel triggers may be combined by trigger-combination logic, and the trigger-combination logic may be inhibited by the retrigger mask while the sequenced recovery operation or back-off interval is active.

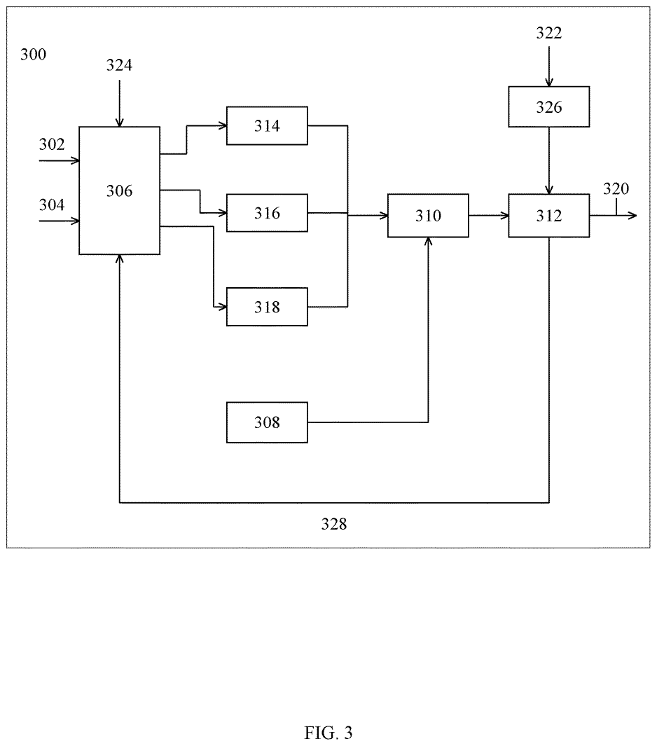

FIG. 3 depicts a persistence counter channel 300 configured to evaluate a programmable enforcement condition for a corresponding violation channel. The channel 300 receives a synchronized level input 302 and, where event detection is used, an event pulse input 304. A mode selector 306 selects among different trigger-evaluation modes. In a preferred embodiment, the supported modes include persistent-level logic 314, heartbeat/window logic 316, and overflow/rate logic 318.

The persistence circuit may include one or more counters, timers, threshold detectors, accumulators, leaky-bucket circuits, comparators, reloadable counters, saturating counters, event counters, window detectors, rate detectors, mode decoders, polarity selectors, enable gates, or equivalent hardware logic configured to determine whether a programmable enforcement condition has been satisfied. Accordingly, although certain embodiments use persistence counters, the persistence circuit is not limited to a counter implementation.

In one concrete implementation, each independently enabled violation channel includes a corresponding persistence counter having a counter width of 16 bits, a threshold or timeout register, channel-enable control, polarity control, and mode-selection control. A configuration bus may load a timeout or threshold value for each channel. The persistence counter may assert a channel trigger when a selected persistent-level, missing-heartbeat, or rate-monitoring condition satisfies the programmed threshold.

In one preferred implementation, enabled channel trigger outputs are combined by a trigger-combination circuit using an OR function gated by the retrigger mask. The trigger-combination circuit may also capture a trigger-source bitmask or priority-selected source identifier. During isolate, purge, resume, or back-off, the retrigger mask prevents the combined trigger from being accepted by the reset sequencer. In some embodiments, persistence counters are frozen during the sequenced recovery operation and are cleared, reloaded, or resumed when self-clear occurs. In persistent-level mode, a channel counter increments while an associated synchronized violation level is asserted. When the count reaches or exceeds a configured timeout threshold, a trigger is asserted. Persistent-level mode is useful for violations that represent a sustained condition, such as a balance register being non-zero, a protocol violation remaining active, a voltage rail remaining outside limits, a thermal condition persisting, or a parity/ECC fault indication remaining asserted.

When multiple violation channels satisfy their respective programmable enforcement conditions during the same enforcement clock cycle or within an overlapping detection window, the enforcement circuit may treat the multiple channel triggers as a single enforcement event. In one embodiment, the channel trigger outputs are combined by an OR tree so that any enabled unmasked channel can initiate the sequenced recovery operation. In another embodiment, a priority encoder selects a highest-priority triggering channel. In another embodiment, a trigger-source bitmask records all channels that satisfied their trigger conditions. In another embodiment, simultaneous triggers are arbitrated by a round-robin selector, fixed-priority selector, encoded source selector, safety-priority policy, or security-priority policy.

The reset sequencer need not perform multiple overlapping sequenced recovery operations for simultaneous channel triggers. Instead, one accepted trigger may initiate a single isolate, purge, and resume sequence for the target logic domain, while source information for one or more triggering channels is captured in a status register, diagnostic register, trace buffer, post-mortem register, or external status interface. During the sequenced recovery operation and back-off interval, the retrigger mask may prevent additional channel triggers from initiating a second recovery sequence until the self-clear condition is satisfied.

In heartbeat or window mode, a channel expects activity within a configured time window. A counter may be loaded with a timeout value and decremented each enforcement clock cycle. Receipt of a heartbeat pulse reloads the counter. If the counter expires before a heartbeat is received, a trigger is asserted. In overflow or rate mode, event pulses increment a counter and time or cycles decrement or decay the counter. If events arrive too frequently, the counter exceeds a threshold and a trigger is asserted.

In a persistent-level implementation, the persistence circuit may operate according to the following example logic, where count is a channel counter and threshold is a programmed timeout value. If the channel is enabled and a fault level is active, the counter is incremented until a maximum count is reached. If the channel is disabled or the fault level is inactive, the counter may be cleared, held, or decayed according to configuration. A trigger may be asserted when the channel is enabled and the counter is greater than or equal to the threshold.

In one example persistent-level implementation, the following logic may be used:
if channel_enabled and fault_level_active:
count=min(count+1, count_max)
else:
count=0
trigger=channel_enabled and (count>=threshold)

In a heartbeat or window implementation, the persistence circuit may operate according to the following example logic. If the channel is enabled and a heartbeat pulse is received, a counter is loaded with the threshold value. If the channel is enabled and no heartbeat pulse is received, the counter is decremented while the counter remains greater than zero. A trigger may be asserted when the channel is enabled and the counter reaches zero.

In one example heartbeat or window implementation, the following logic may be used:
if channel_enabled and heartbeat_pulse_received:
count=threshold
else if channel_enabled and count>0:
count=count−1
trigger=channel_enabled and (count==0)

In a rate-monitoring or overflow implementation, the persistence circuit may operate according to the following example logic. If the channel is enabled and an event pulse is received, a bucket counter is increased by an increment value until a maximum bucket value is reached. If no event pulse is received, the bucket counter may be decreased by a decay value. A trigger may be asserted when the channel is enabled and the bucket counter is greater than or equal to the threshold.

In one example rate-monitoring or overflow implementation, the following logic may be used:
if channel_enabled and event_pulse_received:
bucket=min(bucket+increment_value, bucket_max)
else if channel_enabled and bucket>0:
bucket=bucket-decay_value
trigger=channel_enabled and (bucket>=threshold)

The above logic expressions are examples. Equivalent counter logic, saturating counters, decrementing counters, leaky-bucket circuits, timers, accumulators, finite-state machines, comparator-based circuits, or programmable logic may be used. In some embodiments, counters are frozen, cleared, reloaded, decayed, or ignored while the retrigger mask is active.

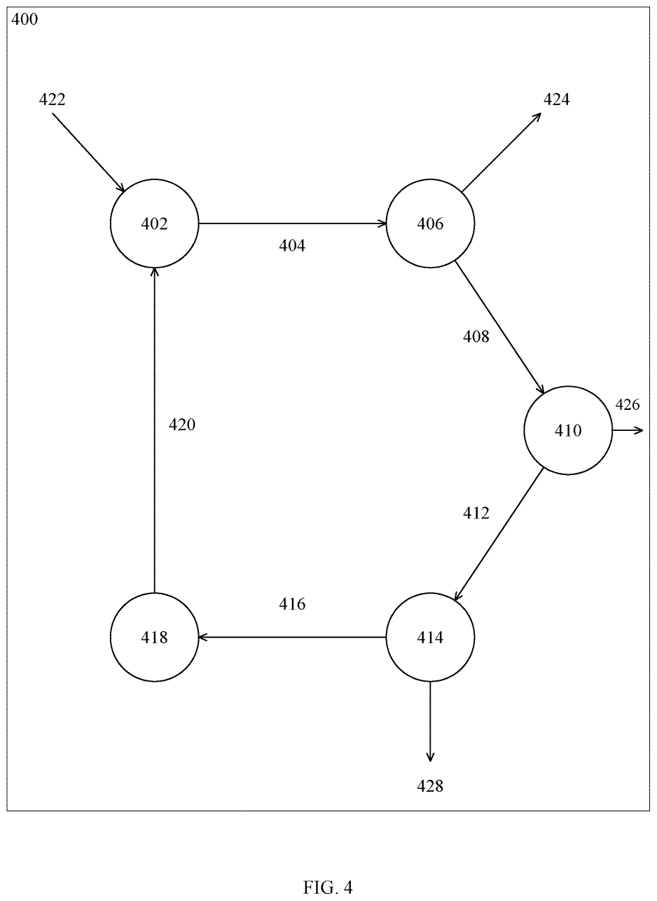

FIG. 4 depicts a reset sequencer state machine 400. The reset sequencer state machine 400 includes a Standby state 402. In the Standby state 402, the enforcement circuit monitors violation conditions while the target logic domain operates normally. Upon receipt of a valid trigger, a trigger transition 404 causes the reset sequencer state machine 400 to leave the Standby state 402 and enter an Isolate state 406.

In one implementation, the reset sequencer includes a standby state, an isolate state, a purge state, a resume state, and a back-off or post-enforcement state. In the standby state, violation monitoring is active and target-domain inhibit, halt, reset, and clearing controls are inactive. When a valid trigger is accepted while the reset sequencer is not masked, the reset sequencer enters the isolate state.

In the isolate state, the reset sequencer asserts one or more target-domain inhibition controls. The inhibition controls may include a halt signal, clock-enable disable signal, write-inhibit signal, commit-inhibit signal, bus-isolation signal, output-valid suppression signal, or other signal that inhibits operation or externally visible state propagation by the target logic domain. The reset sequencer exits the isolate state after an isolate duration counter expires, after an isolate condition is acknowledged, or after another configured isolate-completion condition occurs.

In the purge state, the reset sequencer applies reset state or clearing state to selected volatile or sequential logic of the target logic domain. In some embodiments, the inhibition control remains active during the purge state. The reset sequencer exits the purge state after a purge duration counter expires, after selected state has been driven to a known condition, or after another configured purge-completion condition occurs.

In the resume state, the reset sequencer releases the reset state or clearing state and permits the target logic domain to resume operation. In some embodiments, reset state or clearing state is released before a halt or inhibition control is released. In other embodiments, the release order is varied according to the reset requirements of the target logic domain. The reset sequencer exits the resume state after a resume duration counter expires, after a target-domain restart condition is satisfied, or after another configured resume-completion condition occurs.

After the resume state, the reset sequencer may enter a back-off state or post-enforcement state. In the back-off or post-enforcement state, the retrigger mask remains active and a back-off timer is running. Diagnostic or status information may also be captured. When the back-off interval expires and no enabled unmasked violation condition remains, the self-clear circuit releases the retrigger mask and the reset sequencer returns to a retriggerable standby condition.

The reset sequencer may be implemented as a one-hot finite-state machine, binary-encoded finite-state machine, counter-decoder sequence, microcoded controller, programmable sequencer, hardwired logic, formally generated RTL, or other equivalent hardware control logic.

Inhibiting operation of at least a portion of the target logic domain may include stopping a clock, gating a clock, disabling a clock-enable signal, preventing instruction issue, preventing instruction commit, blocking a write operation, preventing update of selected registers, suppressing an output-valid signal, blocking external propagation of state, isolating a bus interface, or otherwise preventing selected state advancement or externally visible state propagation. The isolate phase therefore need not require a dedicated halt pin, provided that the enforcement circuit causes operation of at least a portion of the target logic domain to be inhibited.

In one preferred implementation, an enforcement clock of the self-resetting hardware enforcement circuit continues to operate while operation of the target logic domain is inhibited. This permits the reset sequencer, back-off circuit, and self-clear circuit to complete the sequenced recovery operation even when a system clock, target-domain clock, or local clock-enable signal of the target logic domain has been halted or inhibited.

Target-domain halt, inhibit, reset, or clearing controls may be synchronized, stretched, level-held, pulse-stretched, asserted asynchronously, asserted synchronously, or applied through reset-safe target-domain control cells according to the clocking and reset requirements of the target logic domain. In some embodiments, the enforcement circuit generates level-held controls that remain asserted for one or more enforcement clock cycles so that the target logic domain reliably observes the control condition.

After the isolate phase, the reset sequencer transitions to a Purge state 410. During the purge phase, reset state or clearing state is applied to selected volatile or sequential logic of the target logic domain. A Purge duration counter 412 determines the purge duration. In the preferred Recognition Science or ledger-enforcement embodiment, the purge phase lasts exactly four enforcement clock cycles.

The purge phase need not be limited to assertion of a literal reset pin. Applying reset state or clearing state may include resetting, clearing, flushing, invalidating, overwriting, reloading, restoring to a known-good value, restoring from a checkpoint, forcing to a safe state, or otherwise driving selected volatile or sequential logic of the target logic domain into a known condition. The selected volatile or sequential logic may include flip-flops, latches, pipeline registers, finite-state-machine state, scoreboard state, control registers, transient execution state, register banks, reset islands, selected sub-blocks, or other non-persistent operating state of the target logic domain.

In some embodiments, the purge phase clears flip-flop state or other selected volatile state while preserving contents of at least one memory array associated with the target logic domain. The preserved memory array may include SRAM, cache data, configuration memory, diagnostic memory, or another memory structure that is not included in the selected reset or clearing domain. This permits targeted recovery of corrupted sequential or transient logic state without necessarily performing a global reset of the entire system.

After the purge phase, the reset sequencer transitions to a Resume state 414. During the resume phase, reset state or clearing state is released and operation of the target logic domain is permitted to resume from a known condition. In one preferred implementation, a reset or clearing control is released before a halt or inhibition control is released, so that the target logic domain is first placed in a known reset or restart state and is then permitted to advance. For example, a target reset signal may be released during a first resume cycle while a halt or inhibition signal remains active, and the halt or inhibition signal may be released during a later resume cycle to permit controlled restart. In other embodiments, the release ordering may be varied according to the reset requirements of the target logic domain.

In a preferred Recognition Science or ledger-enforcement embodiment, the phase durations are fully determined for the default enforcement sequence: the isolate phase lasts exactly two enforcement clock cycles, the purge phase lasts exactly four enforcement clock cycles, and the resume phase lasts exactly two enforcement clock cycles. The total default enforcement duration is exactly eight enforcement clock cycles. The preferred 2+4+2 enforcement sequence is deliberately structured and should not be described as merely incidental in embodiments where Recognition Science timing is being claimed. However, unless a claim expressly requires the Recognition Science timing, the broader enforcement circuit may use other phase durations.

An enforcement octave refers to an eight-cycle enforcement sequence corresponding to an eight-tick cadence of an execution frame.

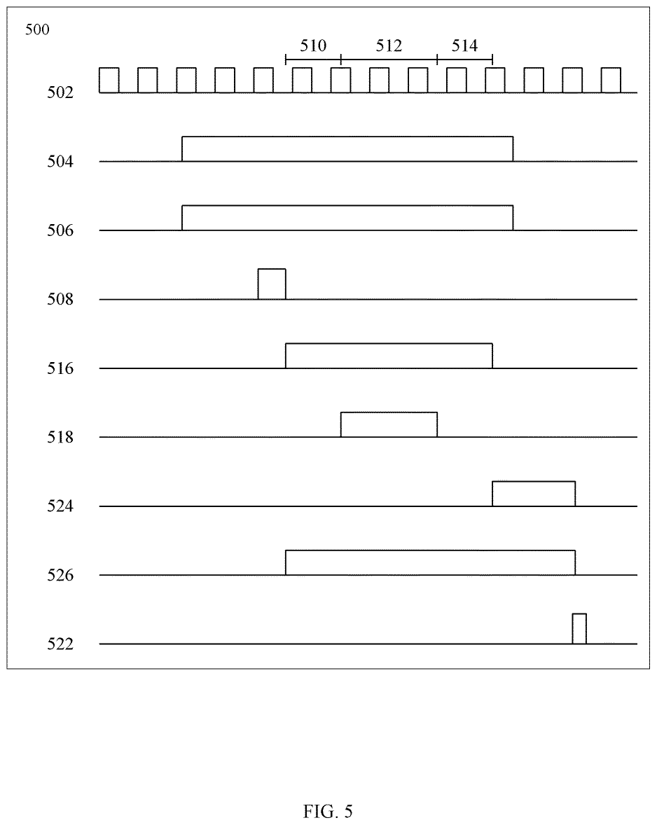

FIG. 5 depicts timing diagram 500 for one enforcement event. An enforcement clock waveform 502 provides timing for enforcement operations. An asynchronous violation waveform 504 represents a violation signal received from a target logic domain or associated monitor. The asynchronous violation waveform 504 is synchronized to produce a synchronized violation waveform 506. When the programmable enforcement condition is satisfied, a trigger pulse 508 is generated. The trigger pulse 508 causes the reset sequencer to begin an enforcement sequence.

An Isolate interval 510 begins after trigger pulse 508. During the Isolate interval 510, a target-domain inhibit or halt waveform 516 is asserted. A Purge interval 512 follows the Isolate interval 510. During the Purge interval 512, a reset or clearing waveform 518 is asserted to apply reset state or clearing state to selected volatile or sequential logic. A Resume interval 514 follows the Purge interval 512. During the Resume interval 514, reset or clearing state is released and the target domain is allowed to resume operation. A self-clear latch waveform 522, back-off active waveform 524, and retrigger mask waveform 526 depict post-enforcement behavior.

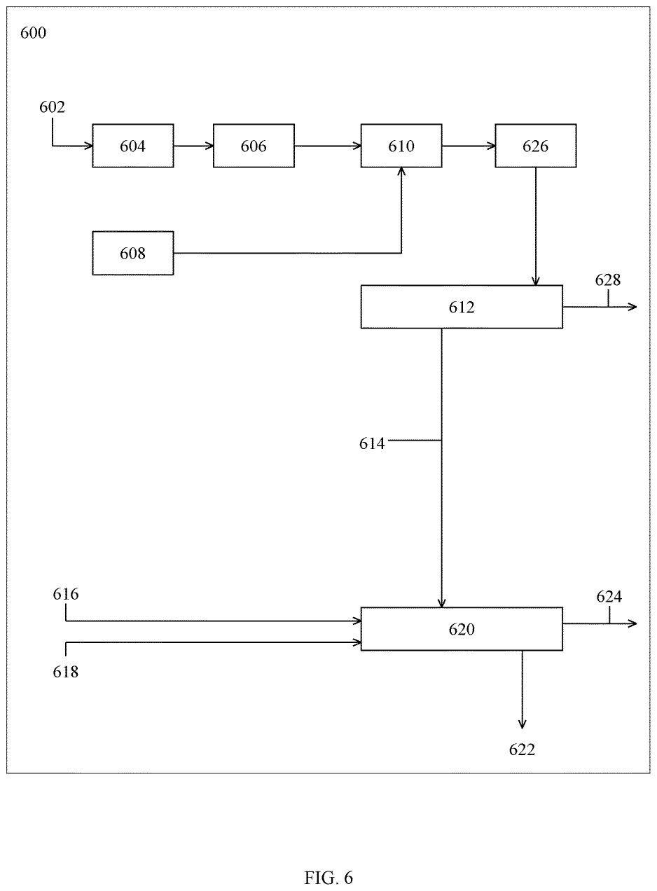

FIG. 6 depicts a back-off and self-clear subsystem 600. The subsystem 600 receives an enforcement event input 602 indicating completion, initiation, or occurrence of an enforcement event. A violation count register 604 may store the number of repeated enforcement events or repeated violations. A back-off exponent register 606 stores an exponent or level associated with the current back-off interval. A base-cycle register 608 stores a base interval. A binary left-shift computation 610 may compute the back-off interval as the base interval shifted by the current exponent.

In one preferred implementation, a back-off exponent or back-off level is updated when the reset sequencer completes the resume phase and enters a back-off state. In other embodiments, the back-off value may be updated upon assertion of the trigger signal, upon entry into the isolate phase, upon entry into the purge phase, upon completion of the sequenced recovery operation, upon entry into a post-resume state, or upon detection of a repeated violation. Thus, increasing the back-off interval after an enforcement event includes updating the back-off interval at a selected point in the lifecycle of the enforcement event.

In a binary-exponential implementation, a base interval is shifted or multiplied according to the back-off level. For example, the back-off interval may be base*2\hat{ }n, where n is a back-off exponent associated with repeated enforcement events. The back-off interval may increase until a maximum back-off value is reached. In one preferred implementation, the maximum back-off value is 2\hat{ }20 enforcement clock cycles, although other maximum values may be used.

Although binary-exponential back-off is preferred in certain embodiments, other back-off policies may be used in other embodiments. The back-off interval may be fixed, linear, exponential, table-driven, randomized, jittered, severity-weighted, channel-specific, policy-controlled, capped, saturating, decaying, or resettable. These alternatives preserve implementation flexibility, while the preferred increasing back-off implementation provides a strong mechanism for preventing repeated reset storms.

In one preferred implementation, the self-clear circuit receives a backoff_expired signal from the back-off circuit, a no_enabled_unmasked_violation signal from the violation monitor or trigger-combination logic, and a sequencer-state signal from the reset sequencer. The self-clear circuit releases the retrigger mask and returns the enforcement circuit to the retriggerable standby condition when the back-off interval has expired, no enabled unmasked violation condition remains, and the reset sequencer is in a back-off state, post-resume state, or other configured post-enforcement state.

Expressed as implementation logic, a self-clear condition may be satisfied when backoff_expired AND no_enabled_unmasked_violation AND sequencer_in_post_enforcement_state are true. This expression provides an objective implementation example and does not require a particular gate-level arrangement. Equivalent hardware, state-machine, latch-based, counter-based, or comparator-based logic may be used to implement the same self-clear behavior.

This expression is provided as one implementation example and does not require a particular gate-level arrangement. Equivalent hardware, state-machine, latch-based, or counter-based logic may be used to implement the same self-clear behavior.

If a violation condition remains enabled and unmasked when the back-off interval expires, the enforcement circuit may remain masked, re-enter the sequenced recovery operation, increase the back-off interval, assert a diagnostic status, or enter another configured post-enforcement state. The selected behavior may depend on channel mode, violation severity, safety policy, security policy, back-off configuration, or system configuration.

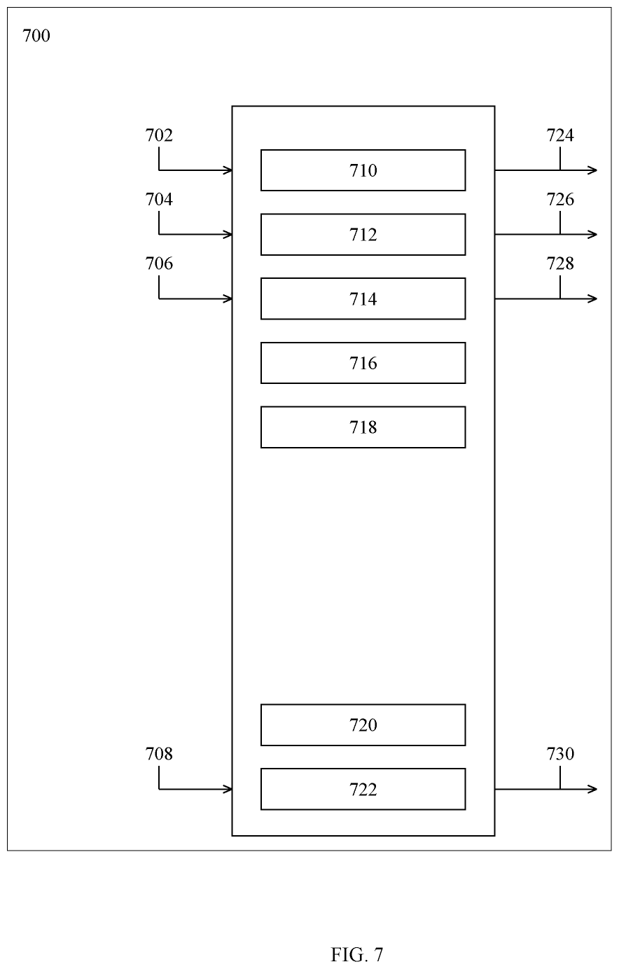

FIG. 7 depicts a hardware interface block 700. The hardware interface block 700 may include a VIOL input bus, a system clock input, an enforcement clock input or generator, a configuration bus, timeout registers, enable registers, mode registers, polarity registers, back-off configuration registers, a status register, and an optional post-mortem register. The status register may store current or recent circuit status, including a sequencer state, violation-source indication, enforcement-active indication, back-off-level indication, or diagnostic information associated with an enforcement event.

Configuration of the enforcement circuit may be hardwired, mask-programmed, fuse-programmed, one-time-programmed, scan-programmed, pin-configured, memory-mapped, register-programmed, boot-time configured, manufacturing-mode configured, test-mode configured, field-configured, or authenticated by a security mechanism. Configuration values may include channel-enable values, polarity values, mode-selection values, timeout values, threshold values, phase-duration values, back-off values, saturation values, diagnostic settings, status-capture settings, lockout settings, or safety-policy settings. In some embodiments, configuration may be locked after provisioning or after boot.

Status and diagnostic information may be captured before, during, or after an enforcement event. Such information may include a trigger-source bitmask, priority-selected trigger source, channel identifier, sequencer state, back-off level, event count, timestamp, cycle count, target-domain status, diagnostic code, post-mortem state, or safety-controller output. Status information may be stored in a register, latch, memory location, diagnostic buffer, trace structure, scan chain, or external status interface.

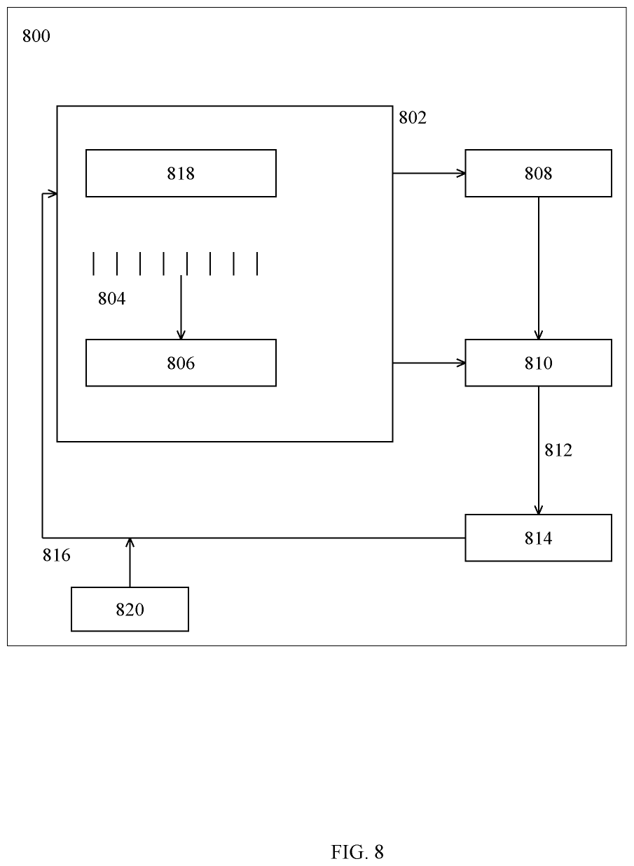

FIG. 8 depicts a ledger-ISA system 800. The ledger-ISA system 800 includes a ledger-enforced processing core configured to execute according to an eight-tick execution frame. A balance register stores a ledger-balance value associated with execution of the ledger-enforced processing core. A frame-boundary detector identifies a boundary of the eight-tick execution frame. A balance non-zero comparator determines whether the balance register has returned to a balanced value at the frame boundary.

If the balance register is non-zero at the frame boundary, a ledger violation signal is asserted. The ledger violation signal is provided to an enforcement circuit instance. Upon enforcement, the ledger-enforced processing core may be inhibited, purged, and resumed from a reset vector or known-good state. In a preferred Recognition Science embodiment, the eight-cycle enforcement sequence corresponds to one eight-tick cadence or enforcement octave. The phase-cancellation identity may be expressed in plain text as sum_{k=0}\hat{ }{7} exp(2*pi*i*k/8)=0. This preferred feature should not be treated as a limitation of all non-ledger embodiments unless expressly claimed.

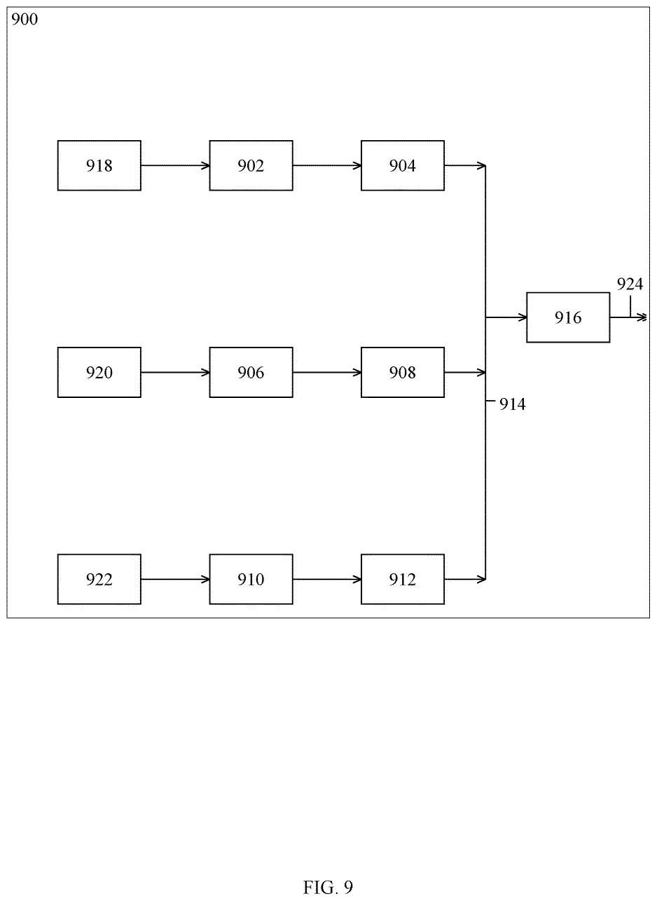

FIG. 9 depicts a multi-domain enforcement system 900. Each target domain may have a corresponding enforcement circuit instance. Each enforcement circuit may operate independently so that one target domain can be recovered without globally resetting all domains. A shared configuration bus may configure the plurality of enforcement circuits, and a diagnostic collector may receive status information from the enforcement circuits.

In further application embodiments, the target logic domain may comprise a safety processor or safety-related processor core monitored by one or more safety monitors. Example monitors include parity monitors, ECC monitors, timing monitors, temperature monitors, voltage monitors, clock-domain monitors, heartbeat monitors, external safety monitors, or combinations thereof. Such monitors may provide violation information to the enforcement circuit. These safety-related embodiments use the same enforcement circuit architecture described with respect to FIGS. 1-7 and may be configured for use in safety-related systems, but this disclosure should not be read as asserting compliance with a particular safety standard merely by inclusion of this embodiment.

In further application embodiments, the target logic domain may comprise a secure enclave, hardware security module, or protected execution block. Example violation sources include voltage-glitch detectors, laser-fault detectors, optical sensors, clock-frequency monitors, instruction-balance detectors, or other physical-attack or fault-injection detectors. The enforcement circuit may inhibit, purge, and resume selected secure logic when a configured violation condition occurs. Optional embodiments may include progressive lockout or permanent disable, but permanent disable is optional and should not be treated as part of the core invention unless expressly claimed.

In downstream or prophetic application embodiments, the target logic domain may comprise a photonic processor controller, phase-shifter calibration controller, photonic control circuit, or related control logic. A photonic imbalance detector may generate a photonic imbalance violation signal when a photonic processor exhibits a configured imbalance condition. The enforcement circuit may reset, clear, reinitialize, or restart phase-shifter calibration logic, photonic control logic, or a calibration sequence. Unless supported by separate validation, photonic processor embodiments should be treated as downstream or prophetic application embodiments of the core enforcement circuit.

In downstream or prophetic application embodiments, the target logic domain may comprise classical control logic associated with a quantum processor, a syndrome decoder, a correction consistency checker, or quantum-error-correction control logic. A syndrome decoder, correction consistency checker, or quantum-error-correction cycle boundary signal may provide violation information to the enforcement circuit. The enforcement circuit may reset, clear, or restart selected classical control logic associated with a quantum processor. These embodiments should be treated as downstream and prophetic unless supported by separate validation and should not be read as requiring quantum hardware for the core invention.

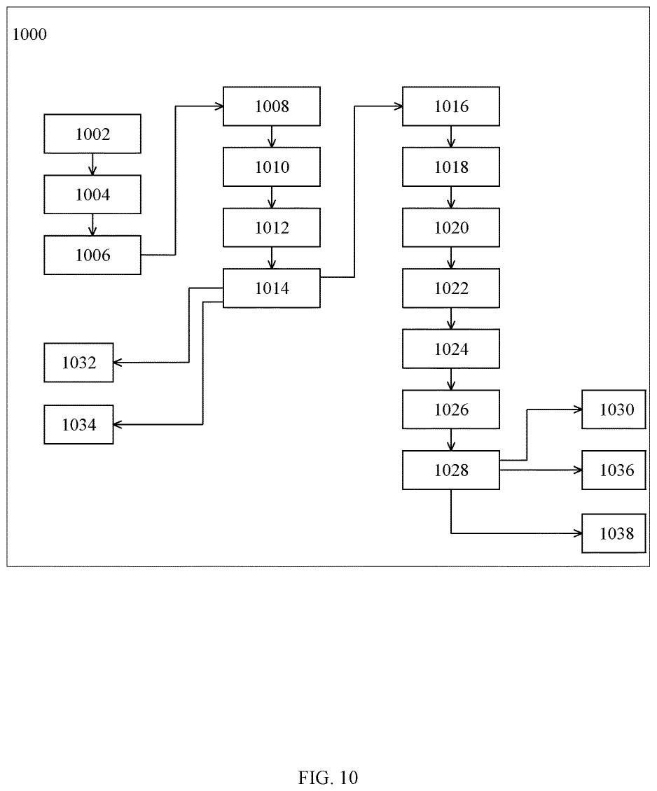

FIG. 10 depicts a formal-to-silicon flow 1000. A Lean 4 specification 1002 may define structures or properties associated with the enforcement circuit. A theorem library 1004 may include proofs relating to reset sequencing, enforcement duration, back-off behavior, self-clear behavior, channel correspondence, or phase cancellation. An enforcement circuit model 1006 may represent the circuit behavior being verified. A reset sequencer proof block 1008, back-off proof block 1010, self-clear proof block 1012, and phase-cancellation or eight-cycle proof block 1014 may support verification of corresponding logical or state-machine properties. An RTL or HDL description 1016 may implement the enforcement circuit, and a simulation or testbench 1018 may validate behavior. A synthesis tool 1020 may synthesize the RTL or HDL description into a gate-level netlist 1022, and a place-and-route flow 1024 may produce a CMOS implementation 1026. Physical measurement or validation block 1028 may support measured implementation data, and a validation report 1030, claim-support artifact 1032, formal proof artifacts 1034, non-transitory computer-readable medium 1036, and configuration or implementation collateral 1038 may preserve verification, implementation, and continuation support.

Formal verification should be distinguished from physical measurement. Formal proofs support logical properties, state-machine properties, timing counts expressed in enforcement clock cycles, and mathematical identities. Physical implementation metrics, including area, leakage, and nanosecond latency, are supported by synthesis, layout, simulation, or silicon measurement. In one demonstrated implementation, the enforcement circuit is implemented in a 5 nm CMOS process and includes eight violation channels, two-flip-flop synchronizers, independent persistence counters, a reset sequencer, binary-exponential back-off logic, and self-clear logic. Formal verification, when used, may verify logical or state-machine properties of the enforcement circuit, including return to standby, default enforcement duration, back-off monotonicity, maximum back-off behavior, self-clear semantics, channel correspondence, or phase-cancellation properties. Physical implementation properties such as transistor-level behavior, silicon area, leakage, propagation delay, dynamic power, or measured latency may be supported separately by synthesis, simulation, layout analysis, emulation, testing, or measured implementation data.

Example physical metrics for one demonstrated implementation include 6,210 standard cells, 0.024 mm\hat{ }2 area, 2.1 uW static leakage, dynamic power less than 0.5 mW at representative clocks, 2.3 ns detection latency from violation assertion to target-domain inhibition, and a 14.4 ns full reset sequence. These metrics are implementation examples and are not limitations of the broader invention unless expressly claimed.

The enforcement circuit may be implemented as a centralized circuit or as distributed logic. For example, the violation monitor may be located near violation sources, the reset sequencer may be located near target-domain clock and reset controls, and the back-off and self-clear logic may be located in a supervisory region. These distributed components may collectively form the self-resetting hardware enforcement circuit when configured to perform the disclosed monitoring, sequenced recovery, back-off, and self-clear operations.

The sequenced recovery operation may be implemented with different numbers of phases in different embodiments. The preferred embodiment includes isolate, purge, and resume phases.

Other embodiments may include additional pre-isolation, diagnostic-capture, drain, quiesce, flush, restore, verify, post-resume, or back-off phases. Future or alternative embodiments may use two-phase or multi-phase recovery operations, provided that selected target-domain operation is inhibited, selected state is forced to or restored to a known condition, and the target logic domain is thereafter permitted to resume operation.

The target-domain control effected by the enforcement circuit may be local, regional, or system-wide. In a local implementation, only a selected sub-block, pipeline stage, register bank, finite-state machine, or reset island is isolated or purged. In a regional implementation, a larger clock domain, reset domain, power domain, core, accelerator, or controller is isolated or purged. In a system-level implementation, multiple target domains may be controlled by respective enforcement circuit instances or by a coordinated plurality of enforcement circuits.

The disclosed enforcement circuit may also be embodied as hardware-description information, including RTL, a gate-level netlist, configuration data, synthesis scripts, place-and-route collateral, formal specification files, formal proof artifacts, or a non-transitory computer-readable medium storing such materials. The hardware-description information may define, configure, verify, synthesize, fabricate, or document the self-resetting hardware enforcement circuit or one or more portions thereof.

The hardware-description or implementation information may include RTL, HDL, Verilog, SystemVerilog, VHDL, a gate-level netlist, configuration data, formal specification data, formal proof artifacts, synthesis scripts, place-and-route collateral, timing constraints, configuration bitstreams, layout data, verification collateral, or other information that defines, configures, verifies, synthesizes, fabricates, or implements the self-resetting hardware enforcement circuit or portions thereof. Such information may be stored on a non-transitory computer-readable medium.

Functional validation of an implementation may include verifying that a configured violation signal produces a trigger, that the trigger causes transition from Standby to Isolate, that target-domain operation is inhibited during Isolate, that reset state or clearing state is applied during Purge, that reset state or clearing state and inhibition are released during Resume, that back-off is applied after enforcement, and that self-clear returns the circuit to a retriggerable standby condition after expiration of the back-off interval when no unmasked violation condition remains.

In one validation protocol, an implementation is accepted when a configured persistent-level violation causes trigger assertion at or after the programmed threshold, a configured heartbeat channel triggers when no heartbeat pulse is received within the programmed window, a configured rate-monitoring channel triggers when event activity exceeds the programmed threshold, the reset sequencer enters isolate, purge, and resume in the programmed order, the target-domain inhibit and reset or clearing controls are asserted and released according to the selected phase durations, the back-off interval increases after repeated enforcement events, and the retrigger mask is released only after the back-off interval expires and no enabled unmasked violation condition remains.

Mode validation may include verifying persistent-level timeout behavior, heartbeat/window expiration behavior, overflow/rate threshold behavior, channel enable behavior, polarity behavior, and simultaneous-trigger behavior. Back-off validation may include verifying that repeated enforcement events increase the back-off interval, that the interval saturates at a configured maximum, that retriggering is masked during back-off, and that self-clear occurs after expiration of the back-off interval without a new unmasked violation condition.

In one operational example, a violation signal associated with a target logic domain is received by the violation monitor. The violation signal is synchronized into the enforcement clock domain and evaluated by the persistence circuit. When the programmable enforcement condition is satisfied, the persistence circuit asserts a trigger signal. The reset sequencer enters an isolate phase and inhibits operation of at least a portion of the target logic domain. The reset sequencer then enters a purge phase and applies reset state or clearing state to selected volatile or sequential logic. The reset sequencer then enters a resume phase and releases the reset state or clearing state so that operation of the target logic domain is permitted to resume. The back-off circuit increases or sets a back-off interval and maintains retrigger inhibition. When the back-off interval expires and no enabled unmasked violation condition remains, the self-clear circuit releases the retrigger mask and returns the enforcement circuit to a retriggerable standby condition.

### Additional Reference Numeral Descriptions

The following additional descriptions identify reference numerals shown in the drawings and may be read together with the corresponding figure descriptions above.

Where a drawing shows an overall reference numeral ending in 00, such as 100, 200, 300, 400, 500, 600, 700, 800, 900, or 1000, that numeral identifies the overall illustrated circuit, channel, subsystem, diagram, system, timing diagram, or process flow shown in the corresponding figure. An enclosing boundary, frame, or other graphical association may be used to associate the overall reference numeral with the illustrated arrangement. Unless expressly stated otherwise, such a boundary or frame is a drawing aid and does not require a separate physical housing, wall, package, or enclosure.

For FIG. 1, the drawings further identify 120 (configuration register/configuration interface); 122 (status register/diagnostic interface); 128 (enforcement clock input); 130 (system or target-domain clock input); 132 (target-domain control-signal group); 134 (selected target logic portion within 102); 136 (mode or threshold configuration input feeding 110); 138 (trigger-acceptance signal path 112 to 114); 140 (self-clear feedback path 118 to 116).

For FIG. 2, the drawings further identify 220 (polarity-configuration input); 222 (channel-enable configuration input); 224 (enabled channel output); 228 (enforcement clock input); 232 (mode or event-selection input); 234 (composite channel output).

For FIG. 3, the drawings further identify 308 (threshold or timeout register); 310 (comparator or mode-output combiner); 312 (trigger latch/trigger gate); 320 (trigger-output path); 322 (retrigger-mask input); 324 (mode or configuration load input); 326 (mask gate); 328 (counter clear/reload/freeze control).

For FIG. 4, the drawings further identify 408 (Isolate to Purge transition); 416 (Resume to Back-off transition); 418 (Back-off state); 420 (Back-off to Standby transition (self-clear)); 422 (trigger-entry path into 402); 424 (isolate-state status output); 426 (purge-state status output); 428 (resume-state status output).

For FIG. 6, the drawings further identify 612 (back-off timer/comparator); 614 (retrigger-mask gate/mask-control path); 616 (no-unmasked-violation input); 618 (sequencer-state input); 620 (self-clear logic block); 622 (self-clear output); 624 (mask-release output); 626 (shifted back-off interval register); 628 (back-off-active output).

For FIG. 7, the drawings further identify 702 (configuration-bus input); 704 (system-clock input); 706 (enforcement-clock input); 708 (violation-bus input); 710 (enable register); 712 (mode register); 714 (polarity register); 716 (timeout/threshold register); 718 (back-off configuration register); 720 (status register); 722 (post-mortem/diagnostic register); 724 (halt or inhibit output); 726 (reset or clearing output); 728 (target-domain control output); 730 (status/diagnostic output).

For FIG. 8, the drawings further identify 802 (ledger-enforced processing core); 804 (per-tick ledger indicators (eight ticks)); 806 (frame-boundary detector); 808 (balance non-zero comparator); 810 (ledger-violation generator); 812 (violation signal path to enforcement circuit); 814 (enforcement-circuit instance); 816 (reset/clear/inhibit feedback path); 818 (balance register); 820 (reset-vector or known-good-state source).

For FIG. 9, the drawings further identify 902 (enforcement-circuit instance, domain A); 904 (target logic domain A); 906 (enforcement-circuit instance, domain B); 908 (target logic domain B); 910 (enforcement-circuit instance, domain C); 912 (target logic domain C); 914 (shared configuration/diagnostic bus); 916 (diagnostic collector/supervisory status block); 918 (violation source(s) for domain A); 920 (violation source(s) for domain B); 922 (violation source(s) for domain C); 924 (system status output).

What is claimed is:

1. A self-resetting hardware enforcement circuit comprising:
a violation monitor configured to receive at least one violation signal associated with a target logic domain;
a persistence circuit coupled to the violation monitor and configured to assert a trigger signal in response to determining that a programmable enforcement condition associated with the at least one violation signal has been satisfied;
a reset sequencer coupled to the persistence circuit and configured to accept the trigger signal only when a retrigger mask does not inhibit trigger acceptance and, in response to accepting the trigger signal, to assert the retrigger mask and perform, without requiring firmware or software intervention, an ordered sequenced recovery operation for the target logic domain, the ordered sequenced recovery operation comprising:
an isolate phase in which operation of at least a portion of the target logic domain is inhibited;
a purge phase, following the isolate phase, in which reset state or clearing state is applied to selected volatile or sequential logic of the target logic domain; and
a resume phase, following the purge phase, in which the reset state or clearing state is released and operation of the target logic domain is permitted to resume;
a back-off circuit coupled to the reset sequencer and configured, after the ordered sequenced recovery operation, to inhibit acceptance of a subsequent trigger signal during a back-off interval, wherein the back-off interval is increased after an enforcement event; and
a self-clear circuit configured to maintain the retrigger mask during at least a portion of the ordered sequenced recovery operation or the back-off interval, and to release the retrigger mask and return the self-resetting hardware enforcement circuit to a retriggerable standby condition only after expiration of the back-off interval when no unmasked violation condition remains.

2. The self-resetting hardware enforcement circuit of claim 1, wherein firmware or software is permitted to configure at least one threshold, channel-enable value, mode-selection value, polarity value, back-off value, or diagnostic setting before an enforcement event or to read status information after the enforcement event, without being required to perform the ordered sequenced recovery operation, inhibit acceptance of the subsequent trigger signal during the back-off interval, or release the retrigger mask.

3. The self-resetting hardware enforcement circuit of claim 1, wherein the violation monitor comprises a plurality of independently enabled violation channels, each violation channel being coupled to a corresponding persistence counter.

4. The self-resetting hardware enforcement circuit of claim 3, wherein the plurality of independently enabled violation channels comprises eight violation channels corresponding to eight stages, ticks, phases, or positions of an execution frame.

5. The self-resetting hardware enforcement circuit of claim 1, wherein the violation monitor comprises, for at least one violation channel, a multi-stage synchronizer configured to synchronize an asynchronous violation input into an enforcement clock domain and to generate at least one of a synchronized level signal or a one-cycle event pulse from the asynchronous violation input.

6. The self-resetting hardware enforcement circuit of claim 1, wherein the programmable enforcement condition comprises at least one of:
a persistent-level condition in which a fault indication remains asserted for a threshold number of enforcement clock cycles;
a missing-heartbeat condition in which a required activity signal is absent for a threshold number of enforcement clock cycles; or
a rate-monitoring condition in which event activity exceeds a programmable threshold.

7. The self-resetting hardware enforcement circuit of claim 1, wherein the retrigger mask prevents assertion of a subsequent trigger signal while the isolate phase, the purge phase, or the resume phase is active and until the back-off interval has expired.

8. The self-resetting hardware enforcement circuit of claim 1, wherein the isolate phase comprises asserting a halt signal or inhibition signal that inhibits a clock signal, a clock-enable signal, instruction issue, instruction commit, write operation, or external propagation of state by the target logic domain.

9. The self-resetting hardware enforcement circuit of claim 1, wherein the purge phase comprises asserting a reset signal or clearing signal that clears flip-flop state of the target logic domain while preserving contents of at least one memory array associated with the target logic domain.

10. The self-resetting hardware enforcement circuit of claim 1, wherein the isolate phase has a duration of two enforcement clock cycles, the purge phase has a duration of four enforcement clock cycles, and the resume phase has a duration of two enforcement clock cycles.

11. The self-resetting hardware enforcement circuit of claim 10, wherein the sequenced recovery operation has a total duration of eight enforcement clock cycles corresponding to an eight-tick cadence of an execution frame or enforcement octave.

12. The self-resetting hardware enforcement circuit of claim 1, wherein an enforcement clock of the self-resetting hardware enforcement circuit continues to operate while operation of the target logic domain is inhibited during at least the isolate phase.

13. The self-resetting hardware enforcement circuit of claim 1, wherein increasing the back-off interval comprises doubling the back-off interval after each of a plurality of enforcement events until a maximum back-off value is reached.

14. The self-resetting hardware enforcement circuit of claim 13, wherein the maximum back-off value is 2\hat{ }20 enforcement clock cycles.

15. The self-resetting hardware enforcement circuit of claim 1, wherein at least one property of the reset sequencer, the back-off circuit, or the self-clear circuit is machine-verified using a formal proof system.

16. The self-resetting hardware enforcement circuit of claim 15, wherein the formal proof system comprises Lean 4, and wherein the at least one property includes at least one of return to standby after the sequenced recovery operation, an eight-cycle default enforcement duration, monotonicity of back-off, a maximum back-off value, self-clear semantics, or eight-channel correspondence.

17. A fault-tolerant computing system comprising:
a target logic domain configured to perform digital processing operations;
at least one violation source configured to assert a violation signal in response to a fault, protocol violation, missing heartbeat, event-rate overflow, or algebraic imbalance associated with the target logic domain; and
a self-resetting hardware enforcement circuit coupled to the target logic domain and to the at least one violation source, the self-resetting hardware enforcement circuit comprising:
a persistence circuit configured to assert a trigger signal when a programmable enforcement condition associated with the violation signal has been satisfied;
a reset sequencer configured, in response to the trigger signal, to perform a sequenced recovery operation comprising inhibiting operation of at least a portion of the target logic domain, applying reset state or clearing state to selected volatile or sequential logic of the target logic domain, and thereafter permitting the target logic domain to resume operation;
a back-off circuit configured to inhibit re-triggering of the reset sequencer for a back-off interval that is increased after an enforcement event; and
a self-clear circuit configured to maintain a retrigger mask during at least a portion of the sequenced recovery operation or the back-off interval, and to return the self-resetting hardware enforcement circuit to a retriggerable standby condition after expiration of the back-off interval when no unmasked violation condition remains.

18. The fault-tolerant computing system of claim 17, wherein the target logic domain comprises at least one of a processor core, safety processor, secure enclave, accelerator, memory controller, quantum-control processor, photonic processor controller, clock-domain-crossing interface, or ledger-enforced processing core.

19. The fault-tolerant computing system of claim 17, wherein the violation source comprises a balance register associated with an execution frame, and wherein the violation signal is asserted when the balance register indicates a non-zero balance condition at a boundary of the execution frame.

20. A method of autonomous hardware enforcement for a target logic domain, the method comprising:
receiving, by a hardware enforcement circuit, at least one violation signal associated with the target logic domain;
determining, by a persistence circuit of the hardware enforcement circuit, that a programmable enforcement condition associated with the at least one violation signal has been satisfied;
asserting, by the persistence circuit, a trigger signal;
in response to the trigger signal, performing, by a reset sequencer of the hardware enforcement circuit, a sequenced recovery operation comprising:
inhibiting operation of at least a portion of the target logic domain during an isolate phase;
applying reset state or clearing state to selected volatile or sequential logic of the target logic domain during a purge phase; and
releasing the reset state or clearing state and permitting operation of the target logic domain to resume during a resume phase;
inhibiting re-triggering of the reset sequencer during a back-off interval following the sequenced recovery operation;
increasing the back-off interval after an enforcement event;
maintaining a retrigger mask during at least a portion of the sequenced recovery operation or the back-off interval; and
returning the hardware enforcement circuit to a retriggerable standby condition after expiration of the back-off interval when no unmasked violation condition remains.
